(19) United States
(12) Patent Application Publication
(10) Pub. No.: US 2012/0278142 A1
(43) Pub. Date: Nov. 1, 2012

(54) Mobile Device Content Server Method and System

(75) Inventor: Yvonne Li, San Jose, CA (US)

(73) Assignee: Mobile Sense, LLC, San Jose, CA (US)

(21) Appl. No.: 13/519,994

(22) PCT Filed: Dec. 23, 2010
(86) PCT No.: PCT/US10/62093

§ 371 Date: Jun. 29, 2012

Related U.S. Application Data
(60) Provisional application No. 61/291,901, filed on Jan. 3, 2010.
(60) Provisional application No. 61/373,226, filed on Aug. 12, 2010.

(51) Int. Cl. G06F 15/16; G06Q 30/02

(52) U.S. Cl. 705/14.1; 709/217

(57) ABSTRACT

Systems and Methods to deliver mobile content to consumers' mobile phone initiated by a “Call-To-Action” statement placed in non-interactive content or by a “Call-To-Action” at events or promotion campaigns. The system delivers requested content using one or more mobile communication channels. The exchange system selects additional ad content that may be of interest to consumers based on attributes of the requested content. The additional content is presented in titles form or links to mobile web pages. Tags are added to the content link and are used to trace content viewed by consumers resulting from response to the titles or links The system provides closed-loop redemption for mobile content that may contain coupons, promotions, event tickets, membership, and others. The redemption process serves as a method for collecting marketing data.

### REFERENCE TO RELATED APPLICATIONS

This application is related to U.S. provisional patent application Ser. No. 61/291,901, filed Jan. 3, 2010, entitled “Ad Exchange and Tracking and Closed Loop Redemption for Non-Interactive Ad Content Using Mobile Communication”; U.S. patent application Ser. No. 61/373,226, filed Aug. 12, 2010, entitled “Mobile Response Storage for Non-Interactive Content and the Serving of Mobile Contextual Content”; all of which are fully incorporated by reference herein.

### FIELD

This invention relates generally to traditional media, mobile contextual content, mobile advertising and mobile ad network.

### BACKGROUND

The total worldwide ad spending in 2008 was close to half a trillion dollars. While 89% of ad budgets still are being spent on traditional advertising, including TV, radio, newspaper, magazine, and out-of-home advertising, only 10% of ad budgets typically is being spent on interactive media, such as online and mobile. This huge percentage difference indicates that consumers still rely heavily on traditional media to receive ad information. However, the key to good advertising is to deliver the right message to the right audience at the right time. By better targeting content or ads to individuals' interest, content providers and advertisers will gain acceptance and continued engagement from consumers.

One disadvantage of traditional ad campaigns is the lack of real time feedback from audience. The performance of these campaigns cannot be monitored or measured until long after the campaigns are over, usually in the form of increase in sales activities. There is no good way to detect campaign results early enough to: (i) reduce wasted resources on ineffective ads and media channels; and (ii) fine tune ad messages and campaign deployment strategies on the fly.

Mobile can improve some of the deficiencies associated with traditional media, such as lack of information recall by consumers, lack of real time campaign performance feedback, and lack of follow-up opportunities. On the other hand, traditional media still has the lion share of the viewership and can provide a larger audience for the ‘Mobile Call To Action’ than mobile media alone. The convergence of traditional media with mobile media is sure to give rise to a new and powerful advertising format.

In more advanced mobile devices, generally known as “Smartphones,” content can be received or delivered via voice, text messaging, email, and mobile Internet. Each of these mobile channels offers different advantages and can be used in conjunction to provide more comprehensive and versatile services.

The cost of placing ads in traditional media is generally more expensive when compared to its interactive counterpart. To increase the return-on-investment (ROI), a system is much needed to allow consumers to connect information that exists in the physical world to information that exists in the cyber world. Hence, a symbiotic relationship can be formed between traditional media and mobile media.

### SUMMARY

The present system and method is directed to saving and storing mobile responses submitted by consumers initiated by “Mobile Call-To-Actions”. The “Mobile Call-To-Action” can be placed in a non-interactive medium, such as TV, radio, prints, posters, billboards, or merchandise, or in an interactive medium, such as on a website. The “Mobile Call-To-Action” can also be announced in a physical location, such as a concert or a sport arena. Consumers can respond to the “Mobile Call-To-Action” using various mobile service, such as mobile apps, voice, emails, SMS, and web apps. “Mobile Call-To-Action” can also include any action that can be performed by a mobile device. The systems can save mobile responses submitted by consumers on servers under the consumers' account.

Mobile responses can serve as an index to content that consumers are interested in receiving. The content can be stored on local servers or on third party remote servers, including in a cloud environment. Consumers can access the saved mobile responses and their associated content on mobile devices using various mobile services, such as mobile apps, emails, SMS, voice, and web apps. During content access, the system can select contextual content to deliver to consumers. The selection process can be based on a variety of criteria, including matching attributes between the associated content and the contextual content. Tags can be inserted into the content that allow the system to trace back to the original mobile user. The system can also provide a method to perform content redemption from the mobile device.

The present system includes: (i) a mobile response server, for receiving over the mobile communication channel, a content request, and ID data representative of the identity of the mobile device; (ii) a content storage server, in communication with the mobile response server, for storing the received request data in association with the ID data; and (iii) a content exchange server, in communication with the content storage server and responsive to the stored content request.

The content exchange server: (i) identifies attributes of the stored request data, wherein the attributes are related to the content request; (ii) identifies contextual data having content related to the identified attributes; and (iii) associates the contextual data with the stored request data. The request data is associated with a mobile call-to-action statement, which may be non-interactive, such as on a physical medium, and may be related to a redemption related to a transaction associated with goods or services. In an embodiment, the request data is associated with a review of the stored received content.

In an embodiment, the content exchange server, in connection with the contextual data, embeds a tag in the contextual data, wherein the tag is representative of the identification (ID) data of the content request. The content exchange server may generate a content ID associated with the contextual data. In yet another embodiment, the content exchange server combines the contextual data and the content ID associated with the contextual data, encrypts the combined contextual data and content ID, and associates a set of rules with the contextual data and the content ID associated with the contextual data, wherein the rules define permitted usage of and/or access to the combined contextual data and the content ID associated with the contextual data. Alternatively, the rules define the number of times the mobile device is allowed access, a range of times the mobile device is allowed access, the number of mobile devices to which the mobile device may authorize access, and the identity of mobile devices to which the mobile device may authorize access. The content exchange server may control access to and/or usage of the combined contextual data and the content ID associated with the contextual data in accordance with the rules.

The system further includes a content delivery server, in communication with the content storage server and content exchange server, for: (i) composing a response-to-mobile device message, wherein the message includes message data related to the contextual data; (ii) storing the composed response-to-mobile device message; and (iii) transmitting composed response-to-mobile device message. The transmitting is by way of a mobile communication channel, email over the Internet, or other available means of electronic transmission.

An embodiment of the present system further includes a content tracking server, in communication with the mobile response server and content creation server, for at least a portion of the contextual data, for generating traceable content associated with the additional content of the contextual data, wherein the traceable content is representative of an audit trail relating to the additional content of the contextual data. The content tracking server stores pointer data in associated with the stored content request, wherein the pointer data is representative of the location of the additional data of the contextual data.

In an embodiment of the present system, the system includes a content creation server, in communication with the content deliver server, content storage server, content exchange server, content tracking server, and content redemption server, for, in response to contextual data received from one or more content provider parties, updating the contextual data associated with the stored request data. In this embodiment, the updated contextual data is representative of an updated version of the contextual data. In an embodiment of the present method, the content creation server makes available to a content provider (CP), a software as a service web-based user interface. In response to a log-on by a content provider, and receipt of a signal from the content provider, indicative of a content provider-desired campaign, the content creation server generates provider-directed content representative of the content provider-desired campaign and CP ID data representative of the identity of the content provider, and stores the provider-directed content in association with the CP ID data. In another embodiment, the system accesses the content provider's server to retrieve content once access is granted by the content provider's server. In an alternative embodiment, the content creation server associates a set of rules with the provider-directed content and the CP ID data associated with provider-directed content, wherein the rules define permitted usage of and/or access to the provider-directed content and the CP ID data associated with the provider-directed content. In an embodiment, the rules define, with respect to the provider-directed content, the number of times the mobile device is allowed access, a range of times the mobile device is allowed access, the number of mobile devices to which the mobile device may authorize access, and the identity of mobile devices to which the mobile device may authorize access.

In another embodiment, the system includes a content redemption server, in communication with the mobile response server, for identifying a redemption portion of the received content request. The redemption portion is indicative of a desired redemption trans action associated with the contextual data, wherein the redemption transaction is defined by terms associated with the transaction. The content redemption server, in response to the redemption identification, effects a redemption associated with the transaction in accordance with the terms.

The present method for serving content to a mobile device in response to a content request over a mobile communication channel includes the steps of: (i) by a mobile response server, receiving over the mobile communication channel, a content request, and ID data representative of the identity of the mobile device; (ii) by a content storage server, storing the received request data in association with the ID data; (iii) by a content exchange server, and in response to the stored content request, identifying attributes of the stored request data, wherein the attributes are related to the content request, identifying contextual data having content related to the identified attributes, and associating the contextual data with the stored request data; and (iv) by a content delivery server, composing a response-to-mobile device message, wherein the message includes message data related to the contextual data, storing the composed response-to-mobile device message, and transmitting composed response-to-mobile device message. In an embodiment, the content delivery server composes the response-to-mobile device message, whereby the message data includes information related to the additional data of the contextual data.

In an embodiment, the contextual data includes additional data having content related to attributes related to but distinct from the identified attributes. An embodiment of the present method includes, by a content tracking server, for at least a portion of the contextual data, generating traceable content associated with the additional content of the contextual data, wherein the traceable content is representative of an audit trail relating to the additional content of the contextual data. In that embodiment and storing pointer data in associated with the stored content request, wherein the pointer data representative of the location of the additional data of the contextual data. In an embodiment, the pointer data is a link.

In an embodiment, the mobile response server is responsive to a subsequent content request received from the mobile device, to enable the content delivery server to compose a response-to-mobile device subsequent message, wherein the subsequent message includes subsequent message data representative of the then-current stored contextual data. Alternatively, the mobile response server is responsive to a subsequent content request received from the mobile device, wherein the content request includes a portion indicative of a request to review stored request data associated with the mobile device, to enable the mobile device to gain viewing access to the contextual data associated with the stored request data associated with the mobile device. The content request may be related to a mobile call-to-action statement, which may be non-interactive, such as on a physical medium, or may be online, such as a website, or any media.

In an embodiment of the present method the contextual data is representative of one or more coupons for redemption in connection with goods offered for sale pursuant to the mobile call-to-action statement. Alternatively, the contextual data is representative of transaction parameters in connection with goods offered for sale pursuant to the mobile call-to-action statement.

In alternative embodiments of the mobile communication channel of the present method and system includes the Internet, supporting voice by way of a VOIP provider and a private branch exchange (PBX), text message by way of an SMS server and a mobile aggregator, mobile web by way of a web app server, e-mail by way of an Internet gateway and an e-mail exchange server, or text-to-e-mail by way of an SMPT gateway and an e-mail exchange server.

In yet another embodiment of the present method, a content creation server, in response to contextual change data received from one or more context provider parties, updates the contextual data associated with the stored request data, whereby the updated contextual data is representative of an updated version of the contextual data.

In yet another embodiment of the present method, a content redemption server identifies the redemption portion of the received content request indicative of a desired redemption trans action associated with the contextual data, wherein the redemption transaction is defined by terms associated with the transaction. The content redemption server then, in response to the redemption identification, effects a redemption associated with the transaction in accordance with the terms. In an embodiment, the mobile response server identifies the received content request indicative of a desired review associated with the contextual data, wherein the stored contextual data for which review is requested is defined by content request. The mobile response server, in response to the review identification, enables viewing access by the mobile device, to the requested contextual data of the stored request data associated with the mobile device.

### BRIEF DESCRIPTION OF THE DRAWINGS

FIG. 1A is a block diagram illustrating the overview of the process flow for consumers to submitted mobile responses from their mobile phones using various mobile services according to at least one embodiment of the present system;

FIG. 1B is a block diagram illustrating the system architecture of the invention and the modules used to process input and output according to at least one embodiment of the present system;

FIG. 2A is a flow chart illustrating the identification and processing of mobile responses received by the ‘Mobile Response Module’ according to at least one embodiment of the present method;

FIG. 3 is a flow chart illustrating the storage and retrieval of mobile responses and content by the ‘Content Storage Module’ according to at least one embodiment of the present method;

FIG. 4 is a flow chart illustrating the process for selecting and tagging of contextual content by the ‘Content Exchange Module’ according to at least one embodiment of the present method;

FIG. 5 is a flow chart illustrating the process for recording and tracking content viewing activities by the ‘Content Tracking Module’ according to at least one embodiment of the invention;

FIG. 6 and FIG. 6B are flow charts illustrating process for validating redemption and deliver redemption result to consumers and store owners by the ‘Content Redemption Module’ according to at least one embodiment of the present system;

FIG. 6C is a flow chart illustrating the redemption process when consumers have requested content that contain coupons, tickets, memberships, etc that require redemption according to at least one embodiment of the invention;

FIG. 6D is a flow chart illustrating the process flow of the Content Request Server according to at least one embodiment of the invention;

FIG. 7 is a flow chart illustrating process for the delivery of content using various mobile services by the ‘Content Delivery Module’ according to at least one embodiment of the present method; and

FIGS. 8A-8E show an example of a web-based user interface of the ‘Content Creation Module’ according to at least one embodiment of the present system and method.

### DETAILED DESCRIPTION

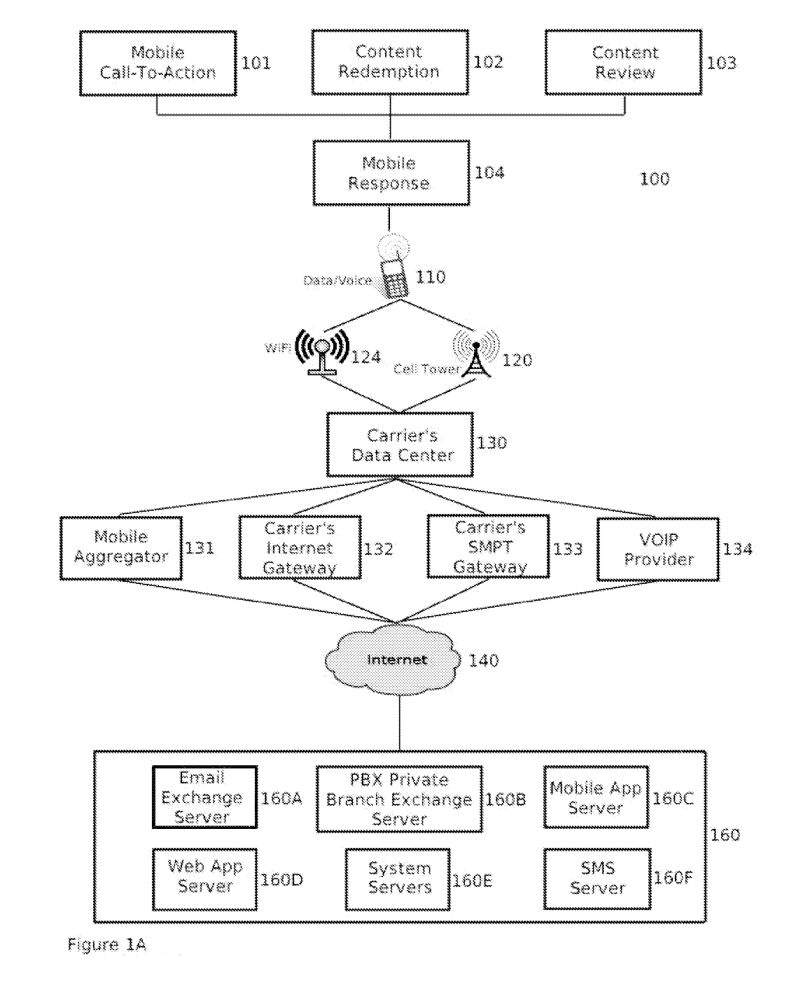

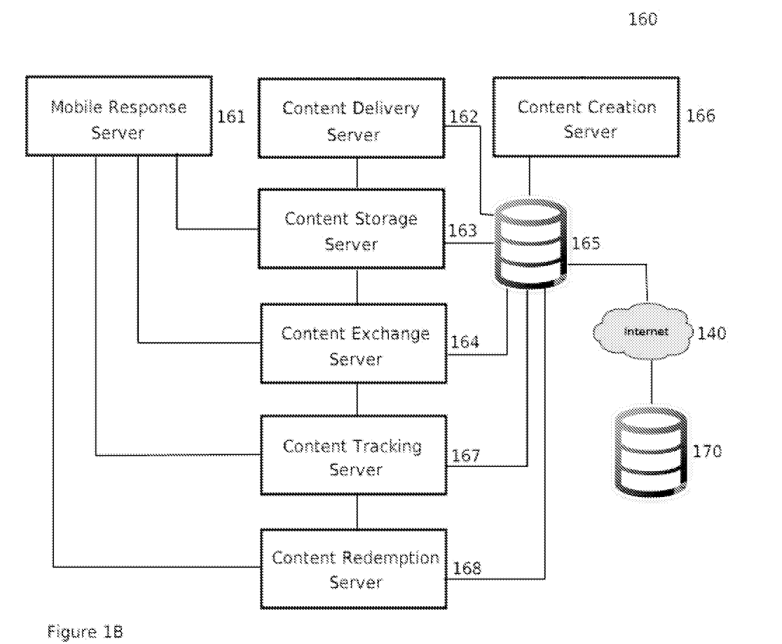

Referring to FIG. 1A, a mobile response 104 is submitted by consumers using a mobile device initiated by an event, such as a Mobile Call-to-Action 101, Content Redemption 102, Content Review 103, and the like. A Mobile Call-To-Action 101 includes a statement placed in non-interactive or interactive content, printed on merchandize, announced in events, or any other mode of providing information to consumers. Content Redemption 102 includes mobile coupons, mobile tickets, mobile memberships, bonus points, and other redeemable media. Review Content 103 is content that consumers have previously saved on the system, as described in further detail below. Thus, the Mobile Call-To-Action 101 statement is used to prompt consumers to respond to the call-to-action using consumers' mobile device.

In an embodiment, the content provider places a Mobile Call-To-Action in the content that is being displayed in a physical medium, and this Mobile Call-To-Action correlates with the content uploaded to the content creation server 166. In another embodiment, consumers take a picture of the content and submit it to the content creation server 166. The content creation server 166 extracts the text from the image and saves both the text and the image to the system database.

In one embodiment, consumers send a text message with a keyword to a short code to submit their mobile response 104. In other embodiments, consumers send their mobile response 104 to a long code number, an email address using text messaging service, or other text based mobile services. Alternatively, consumers submit their mobile response 104 using a mobile app or a web app provided by the system 160 or by making a voice call.

In one embodiment, the mobile response 104 submitted by consumers from their mobile phone 110 is transmitted to carrier's data center 130 via over-the-air cell towers 120 or Internet based transmission, such as WiFi 124, or other wireless transmission technologies, such as WiMax. In one embodiment, if a text message is sent to carrier data center 130 using a short code or a long code, the carrier relays the text message to the mobile aggregator 131 that is hosting the short or long code. The mobile aggregator 131 then sends the text message to the system 160 over the Internet 140. In another embodiment, if a text message is sent to carrier data center 130 using an email address, the carrier relays the text message through its SMTP gateway 133 and over the Internet 140 to the system 160 email exchange server 160A. The Email Exchange Server 160A can periodically poll the incoming mailbox to see if any email has arrived. If an email is sent from consumers' mobile device 110 using an email client software, the carrier 130 can send the email through its Internet gateway 132 and over the Internet 140 to the system's email exchange server 160A. If consumers use a mobile app or a web app to submit the mobile response 104, the carrier 130 can send the mobile response 104 through its Internet gateway 132 and over the Internet 140 to the system's mobile app server 160C or web app server 160D. If consumers make a call using a voice line to submit their mobile response 104, the carrier 130 can connect the voice call to a VOIP provider 134. The VOIP provider 134 can then relay the call to the system's Private Branch Exchange Server (PBX) 160B. The PBX 160B can capture the mobile response 104 using DTMF (dual-tone multi-frequency) or voice recognition software and then send the mobile response 104 to the system's Mobile Response Server 161.

Referring specifically to FIG. 1B, the system described herein includes of one or more of the following servers: an Email Exchange Server 160A, to poll and to receive incoming emails that contain mobile responses; a Private Branch Exchange Server 160B, to receive calls from consumers to submit mobile responses; a Mobile App Server 160C, to send and receive mobile responses and content to a mobile app installed on consumers' mobile device; a Web App Server 160D, to send and receive mobile responses and content to a web app running on a browser on consumers' mobile device; as SMS Server 160F, to send and receive text messages to consumers using services provided by mobile aggregators via the Internet.

The system preferably includes, as shown in FIG. 1B: (i) a Mobile Response Server 161 to process mobile response submitted by consumers using various mobile services; (ii) a Content Delivery Server 162 to deliver content to consumers using various mobile services; (iii) a Content Storage Server 163 to save and retrieve mobile response data submitted by consumers and content submitted by content providers; (iv) a Context Exchange Server 164 to locate and identify associated content and contextual content that consumers are interested in receiving; (v) a database 165 to store and retrieve mobile responses, content associated to mobile responses, user account information, content review history, redemption history and others; (vi) a Content Creation Server 166 for content providers to create and upload content; (vii) a Content Tracking Server 167 to track content viewing activities and to minimize click fraud activities; (viii) a Content Redemption Server 168 to process, validate, and record redemption; (ix) remote third party systems and databases 170 that contain content to be served to consumers. The system servers 160 can be the same or different servers, depending on the implementation of various embodiments. In other embodiments, some servers can be used independently, while some servers can be used with third party systems equipped with software or hardware interfaces.

Referring to FIG. 1B, upon receiving a mobile response 104, the Mobile Response Server 161 identifies the type of mobile response 104 and generates the necessary actions required to process the mobile response 104. The Mobile Response Server 161 parses the mobile response data and related information, such as consumers' mobile number, mobile service used, mobile response type, response actions, date, time, and the like, to the Content Storage Server 163 for storage. After the Content Storage Server 163 receives the data, the data can be stored in the database 165 for future references. The data can then be parsed to other modules for processing.

If the mobile response 104 type is a Mobile Call-To-Action 101, the data is parsed to the Content Exchange Server 164 where the module 164 identifies and assembles the content associated with the mobile response 104 for the delivery to consumers. The content can be retrieved from the database 165 or from remote third party systems or databases 170 via APIs. The Content Exchange Server 164 can further identify contextual content in which consumers may also be interested based on the attributes of the associated content. The titles or short descriptions of the contextual content can be converted to links and tagged with special IDs so that the system 160 can track consumers' viewing activities. The tagged links can also help to detect click fraud activities. The special IDs and the tagged links preferably are stored in the database 165 for future reference. The assembled content is then parsed to the Content Delivery Server 162 for delivery.

If the mobile response 104 type is identified as a content redemption 102, the data is parsed to the Content Redemption Server 168 for processing. That server 168 validates the redemption and sends the result and other related information back to the consumers, the store owners, or both. The redemption result is then parsed to the Content Delivery Server 162 for delivery. The redemption result can also be saved to the system's database 165.

If the mobile response 104 type is identified to be a content review 103, the data can be parsed to the Content Exchange Server 164 where the server 164 can look up the response history of the consumer who submitted the mobile response 104. The mobile response 104 can contain information on the type of content that the consumer is interested to review. Based on the response history and the content review information, the server 164 can then assemble the content that the consumer wants to review. The server 164 can further identify contextual content that the consumer may also be interested in based on the attributes of the requested content from either database 165 or database 170.

The titles or the short descriptions of the contextual content can be converted to links tagged with special IDs. The content delivery can contain the associated content and the links of the contextual content. If consumers are interested in viewing the contextual content, they can click on the links to review the full content. The system 160 can track consumers' content viewing activities and the tagged links can help to minimize click fraud activities. The tagged IDs are stored in the database 165 for future reference. The final content can then be parsed to the Content Delivery Server 162 for delivery.

The Content Delivery Server 162 can deliver the final content using various mobile services. The selection of the mobile services for the content delivery depends on system criteria and consumers' preferences. Mobile services, such as mobile app, web app, and email can accommodate large content size, hence sending contextual content generally does not present a problem. In the case of text messaging, contextual content may or may not be sent along with the associated content due to the limited content capacity. The content can be delivered to consumers' mobile phone 110 using various mobile and telephone exchanges, as stated above, to which the system 160 is connected and has service with via the Internet 140.

The Content Creation Server 166 provides a “Software as a Service” utility for content providers to create content over the Internet. Content can be stored on the system database 166 or on a remote third party database 170. Content attributes and content access criteria can also be entered by the content providers at the time of the content creation. Once the content is created and uploaded, the content can be made available to consumers.

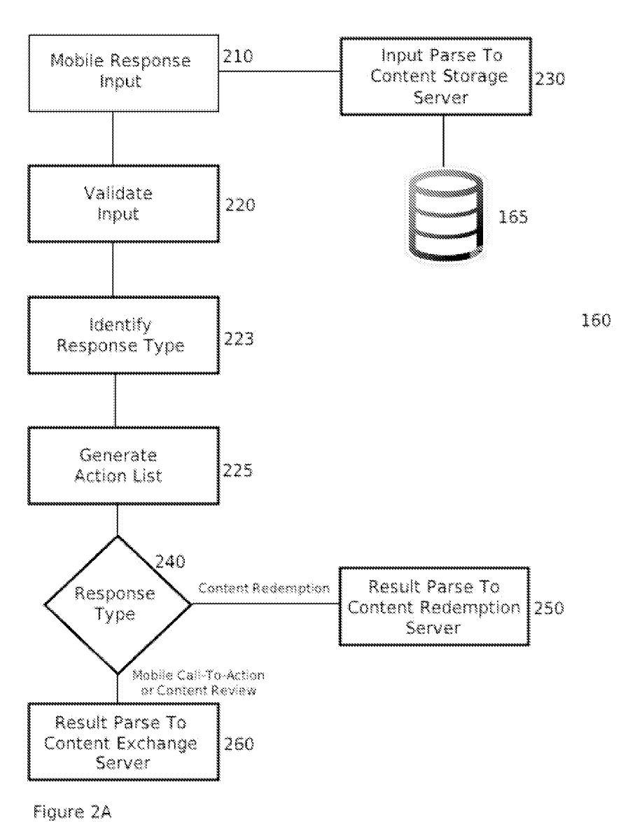

Referring to FIG. 2A, in one embodiment, the Mobile Response Server 161 receives mobile response input 210 submitted by consumers using various mobile services. The mobile response input 210, together with other system data such as mobile service used, consumers' mobile phone number and time stamp is parsed and sent 230 to the Content Storage Server 163 where the server 163 saves the data to the system's database 165. Consumers access saved mobile responses 104 using various mobile services at any time. Consumers then can collect content in which they are interested and place the content in one place for future access. The Mobile Response Server 161 can then validate the input 220, determine the response type 223 and generate a list of corresponding actions 225 to be executed by other servers.

In one embodiment, if the response type is a “Mobile Call-To-Action” 101, the Mobile Response Server 161 examines if the mobile response input 210 is valid by searching the keywords of the mobile response input 210 in the system's database 165. The database 165 contains other information related to the mobile response 210, such as actions to be taken upon receipt of the mobile response, the expiration date, the maximum number of recipients and content that is associated with the mobile response. In one embodiment, the actions include notification to content providers upon receipt of the mobile response or update content providers' inventory database upon receipt of the mobile response or the type of content to reply back to consumers upon receipt of the mobile response. The Mobile Response Server 161 then generates an action list 225 and parses 260 the information to the Content Exchange Server 164 for further processing. In another embodiment, if the response type is a content redemption 102, the Mobile Response Server 161 identifies the input 210 by detecting the keyword REDEEM or the keyword REDEEM plus additional keywords, or other such designated phrases are associated with the redemption. The Mobile Response Server 161 validates the redemption by matching the consumer's mobile device ID, such as the mobile phone number, and the additional keywords to the database 165.

If no additional keyword is provided, the Mobile Response Server 161 maps the redemption to the last response that consumer submitted using consumer's mobile ID. The Mobile Response Server 161 then generates an action list 225 and parses 260 the information to the Content Redemption Server 168 for further processing.

In yet another embodiment, if the response type is a Content Review 103, the Mobile Response Server 161 identifies the input 210 by detecting the keyword REVIEW or the keyword REVIEW plus additional keywords, or other such designated indicia associated with the content review. The content that can be reviewed by consumers are the ones that consumers have saved previously. For example, if consumers submit the keywords REVIEW HEALTH, the Mobile Response Server 161 looks up from the system database 165 if consumers have previously submitted this keyword HEALTH. If so, the Mobile Response Server 161 locates the content that is associated with this keyword. Alternatively, the Mobile Response Server 161 searches the keyword HEALTH in the content that consumers saved previously. If there is no additional keywords provided, the Mobile Response Server 161 locates the latest mobile responses that consumers submitted. The Mobile Response Server 161 then generates an action list 225 and parses 260 the information to the Content Exchange Server 164 for further processing.

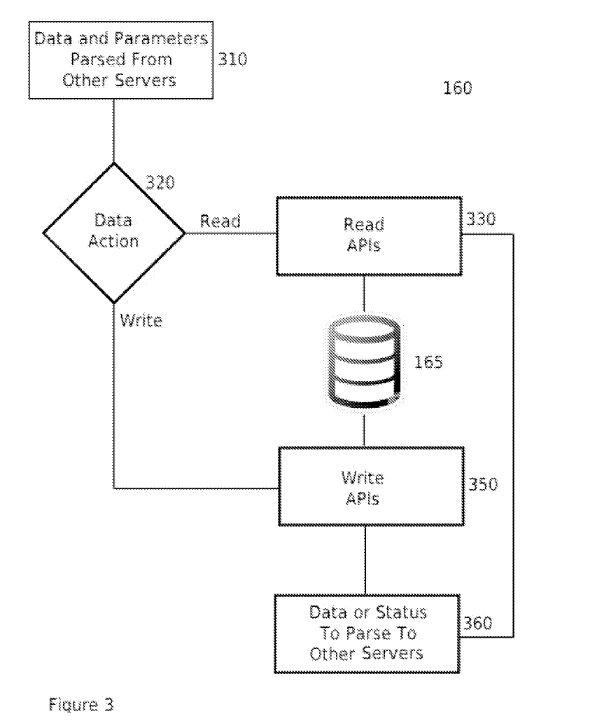

Referring to FIG. 3, in one embodiment, the Content Storage Server 163 receives inputs 310 from other modules in the system 106 to retrieve data or to store data to the system databases 165. If the request is to retrieve data, the retrieval parameters 310 are used by the read APIs 330 to locate the information in the system databases 165. The read APIs 330 issue query commands to retrieve data from the system local databases 165. The read APIs 330 also communicate with remote third party systems and databases when interfaces are provided by the remote systems for data access. The retrieval parameters can contain the information on which database to access, locally or remotely, and the index of the content to be retrieved. After retrieving the data, the read APIs 330 parse the information to other modules 360 for further processing. If the request is to store data on the database, the write data and parameters 310 are parsed to the write APIs 350. Using the write parameters 310, the write APIs locate the database 165 to which to write, locally or remotely, and to compose the data format for the write operation. The write status can then be parsed to other modules 360.

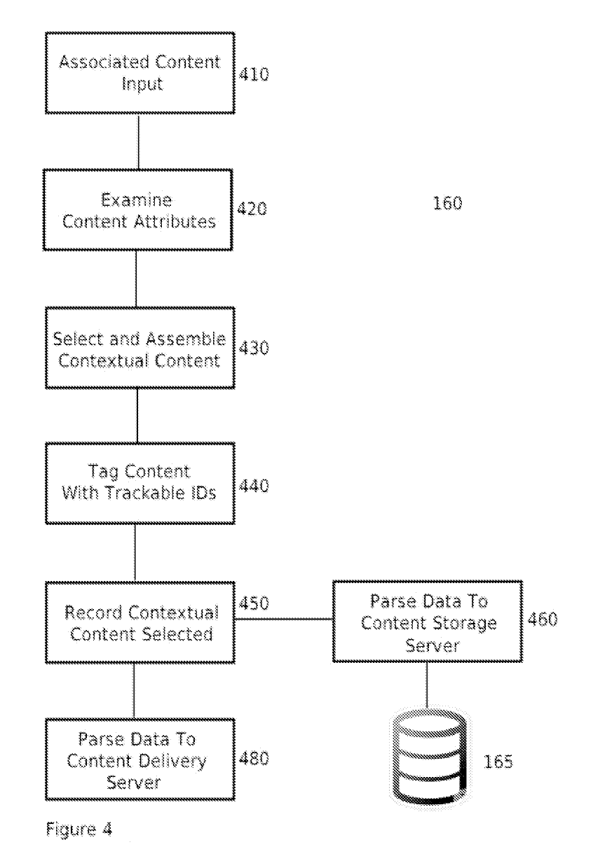

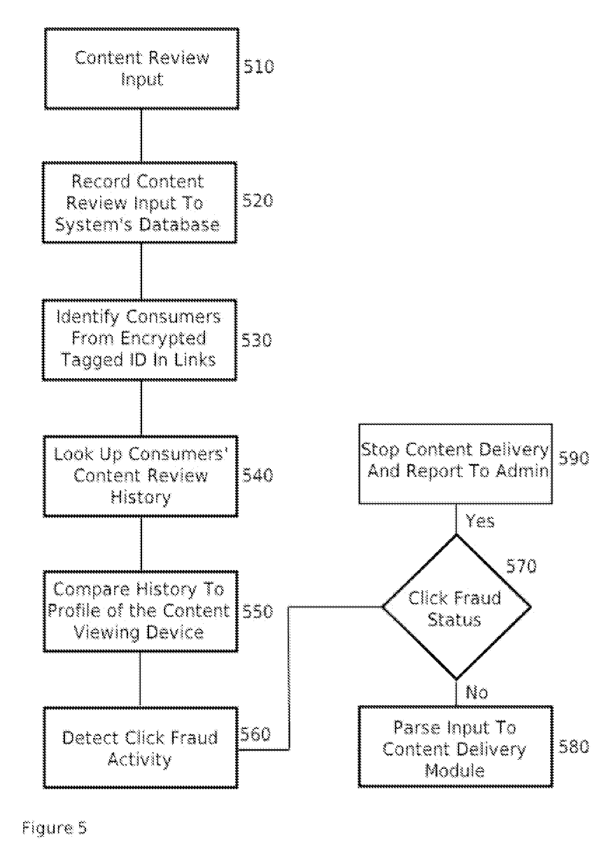

Referring to FIG. 4, in one embodiment, the Content Exchange Server 164 receives inputs 410 related to the mobile response 104 from the Mobile Response Server 161. The Content Exchange Server 164 then locates the content from the system's database 165 and examine the attributes 420 associated with the content, such as content description, product type, geo-location information, associated keywords, and the like. Using predetermined content attributes and criteria, the Content Exchange Server 164 selects contextual content that consumers may also be interested in receiving. The selection of contextual content can also be based on the popularity of content, the degree of relevancy, geo-location distance, consumers' response history, and other predetermined parameters.

In one embodiment, the contextual content is presented as titles or short descriptions and converted into links. In another embodiment, the contextual content is presented in its entire form. The Content Exchange Server 164 then assembles the final content that contains the associated content and the contextual content in a format that matches the mobile service used for the content delivery 430. The Content Exchange Server 164 can also tag the content links with encrypted ID numbers that tie to the individual consumers 440 who submitted the mobile response 104.

In one embodiment, the encrypted ID is generated by combining the consumers' mobile number and the content ID number, and then encrypting the combined number. In another embodiment, the consumers' mobile number, the content ID number, and a unique ID number are entered into a database table. The unique ID number is then encrypted and used as the tagged ID in the link. When consumers click on the links, the system 160 identifies the individual consumer and record the viewing activities. The tagged links can be used to calculate how many times the content has been viewed by consumers. The system 160 can also detect how many times an individual consumer views the content and how many times a link has been forwarded. In the case where content providers are paying a fee for every content served and viewed, this technique can be used to detect a possible click fraud scenario and the system can stop that consumer from further viewing any content. The Content Exchange Server 164 can record the contextual content served 450 to the system database 470. The final content can then be parsed over to the Content Delivery Server 162 for further processing.

Referring to FIG. 5, in one embodiment, the Content Tracking Server 167 receives content viewing activities information 510 when consumers click on a tagged link with an encrypted ID number to view content. The Content Tracking Server 167 records the content viewing activities to the system database 520. The Content Tracking Server 167 then identifies the consumer to whom the tagged link was originally delivered 530 from the encrypted ID in the link. The Content Tracking Server 167 then retrieves the content viewing history of the identified consumer from the system database 540. The Mobile Response Server 161 can also identify the mobile number or the IP address of the mobile device in which the current viewing activity is originated from 550. If the link is being forwarded, the viewing device used may or may not match the device that is used to receive the link. Using the information about the viewing device and the viewing history of the consumer, the Content Tracking Server 167 can determine if the viewing behavior fits the normal pattern 560. If the consumer's content viewing activities, including forwarded links, is above the normal by some predetermined threshhold amount, the Content Tracking Server 167 issues a possible fraud status 590 and interrupts the content delivery. If the viewing behavior fits the normal or predetermined pattern, an “OK” status is issued and the content is delivered 580.

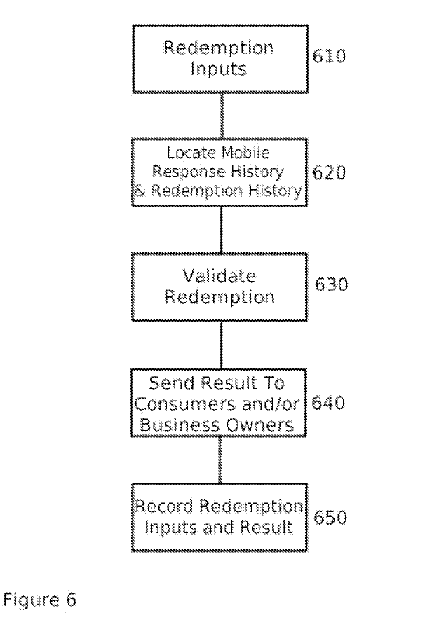

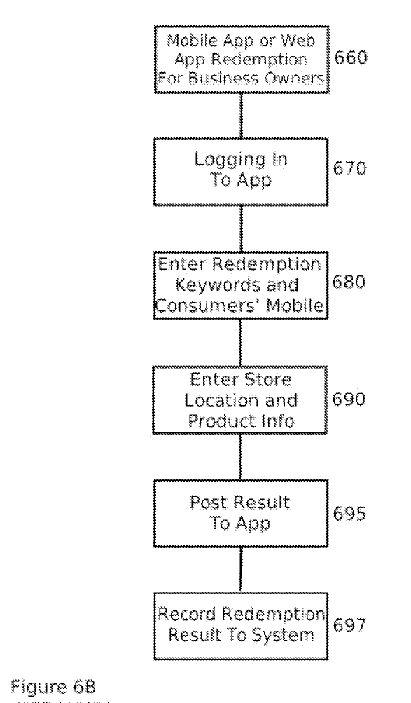

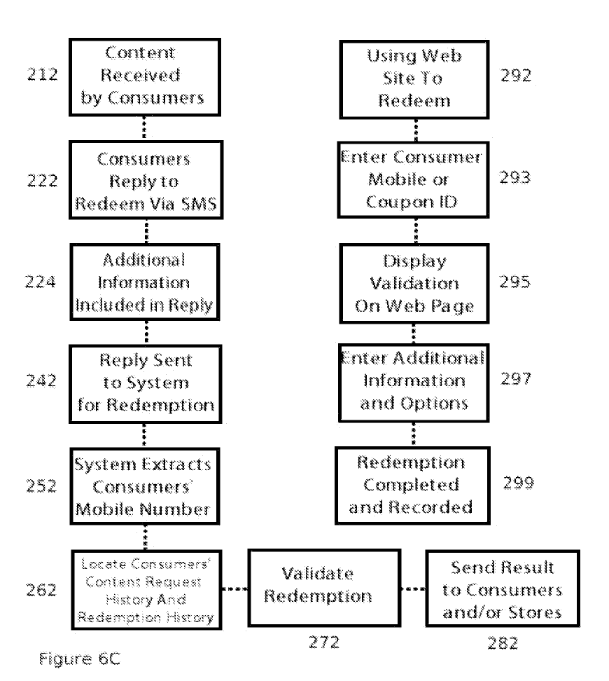

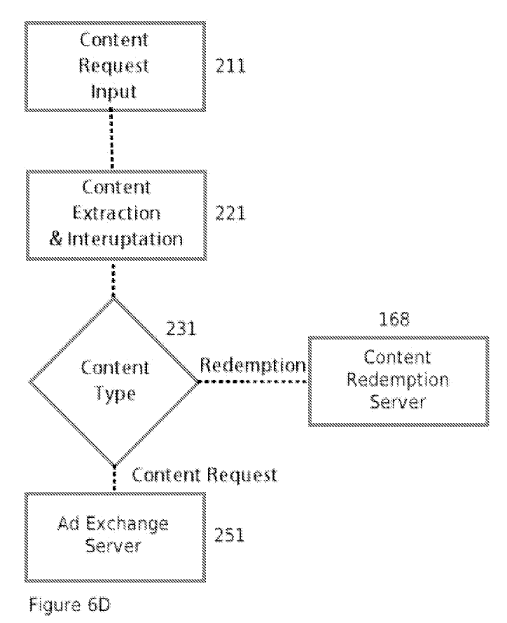

Referring to FIG. 6, in one embodiment, the Content Redemption Server 168 can receive redemption input 610 from the Mobile Response Server 161 and validate the redemption submitted. The redemption 610 can comprise consumers' mobile number, redemption keywords, date, time, and the like. From the redemption input 610, the Content Redemption Server 168 can use consumer's mobile number or other mobile ID to locate the mobile response history and the redemption history 620 of the consumer from the system database 165. From the mobile response history, the Content Redemption Server 168 can locate the campaign that is associated with the redemption. The Content Redemption Server 168 can then validate 630 the redemption using the criteria setup in the system for this campaign. In one embodiment, the campaign allows consumers to redeem once a week based on the consumers' mobile number.

In another embodiment, the campaign allows consumers to redeem only from 9 am to 5 pm Monday through Friday. Redemption criteria can also comprise expiration date, maximum number of redemption allowed and location of redemption. If the redemption satisfies all the campaign criteria, the Content Redemption Server 168 sends the result back to consumers or to content providers who created the campaign or both 640. The Content Redemption Server 168 can then record the redemption inputs and result on to the system database 650.

Referring to FIG. 6B, in another embodiment, redemption can be validated using a mobile app or a web app by store owners using a mobile device or a computer 660. In an embodiment, the mobile app or the web app contains a redemption button, where consumers can click or otherwise activate a button to send a redemption request to the Content Redemption Server 168. The mobile app or the web app sends redemption data and any mobile ID data to the Content Redemption Server 168 and displays the result on the mobile device. Store owners can log in to the app 670 and enter the redemption keyword and the consumers' mobile number for the validation 680. Store owners can enter additional information, such as store location or item to be redeemed 690. The Content Redemption Server 168 then validates and posts the result back to the mobile app or the web app 695. All redemption data and results can be stored in the system database 165 for future reference 697.

Referring to FIGS. 6C and 6D, in an alternative embodiment, if content received by consumers 212 is a coupon, an event ticket, or a membership that requires redemption, consumers can reply 222 to the content with a pre-assigned word such as ‘redeem’ to validate the coupon, ticket or membership. Each coupon, ticket or membership may contain a unique ID number that can be used for the redemption process. Additional information may also be sent in the reply 224, such as the name of the promotional campaign, the store name or location, name of the item to be redeemed, or other survey data.

As shown in FIG. 6D, when mobile response data is received 211 by the Mobile Response Server 161, the server 161 extracts 221 information from the content to determine the content type 231. If the content type is a redemption, the Mobile Response Server 161 sends the content to the Content Redemption Server 168. Content request data is sent to the Ad Exchange Server 151. From the redemption reply 242, the system 160 extracts consumers' mobile number 252, or other mobile device identification, and use it to locate both the consumer content request history and the redemption history 262 from the database 165. In an embodiment, the content request comes from a mobile user who is not the owner of the content, but who is allowed to view the content when the content owner gives permission.

Using content request history 262, together with information 224 in the redemption reply, the system 160 locates the promotional campaign that is associated with the content previously requested by consumers. The system 160 then validates 272 the redemption using criteria being set up for the promotional campaign. In one exemplary embodiment, redemption criteria allows consumers to redeem coupons once a week based on the mobile number. In another exemplary embodiment, redemption criteria allows consumers to redeem coupons from 9 am to 5 pm. In one embodiment, the system 160 sends the validation result back to consumers' mobile phone 282 as text message, email, or mobile web page depending on the mobile channel used. In another embodiment, the validation result, together with consumers' mobile device identification number or the coupon ID is be sent directly to store owner 282.

In another embodiment, validation is obtained from a web site 292. Store owners log in to a web page and enter the coupon ID or consumers' mobile number 293 to check the validation status. The system 160 uses either the content ID and the consumers' mobile device ID to locate the promotional campaign and its associated redemption criteria and displays the status on the web page 295. Store owners may require that additional, verification data, be entered, such as store location or item to be redeemed. Such criteria are predetermined by the creator of the coupon or other redemption device and stored in the system 160. In that embodiment, once the store owner selects the ‘redeem’ option 297, the system 160 records the action in the redemption history database 299.

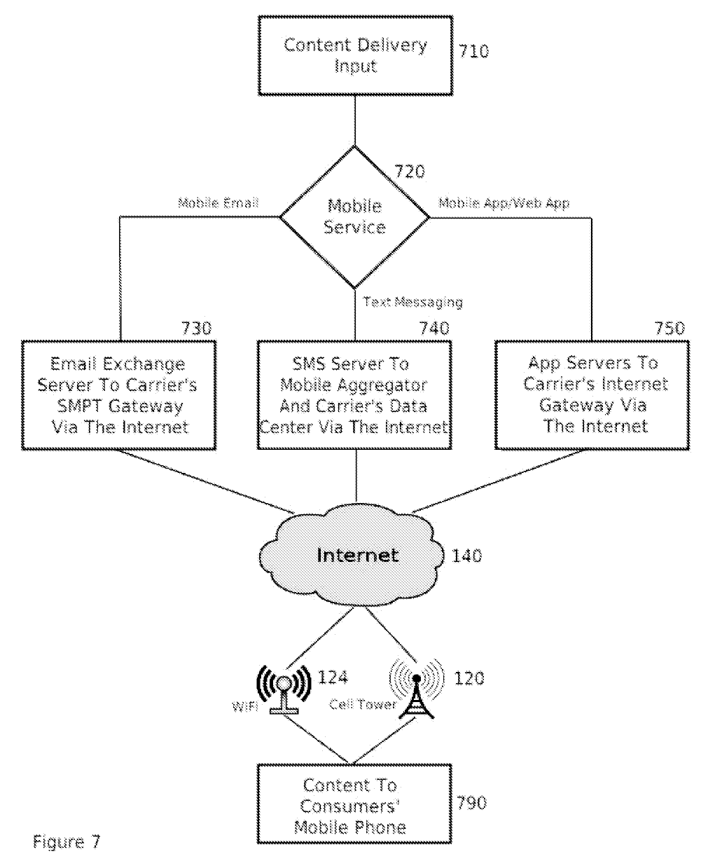

Referring to FIG. 7, in one embodiment, the Content Delivery Server 162 can deliver associated content, contextual content or redemption results 710 to consumers' mobile device 790 via various mobile services 720. The mobile services 720 are selected based on system criteria and user preferences. In one embodiment, the content is delivered using text messaging service, and the Content Delivery Server 162 sends the content to the mobile aggregator 740 via the Internet 140. The mobile aggregator 740 relays the content to the mobile carrier 124, the carrier 124 then sends the content to consumers' mobile device 790. In another embodiment, the Content Delivery Server 162 parses the content 710 to the system's email server 730. The content then is sent over the Internet 140 to consumers' email account, which can be viewed by a mobile device 790 or by a computer. In yet another embodiment, the Content Delivery Server 162 sends the content to a mobile app or a web app 750 via the Internet 140 and the carrier's Internet gateway 132.

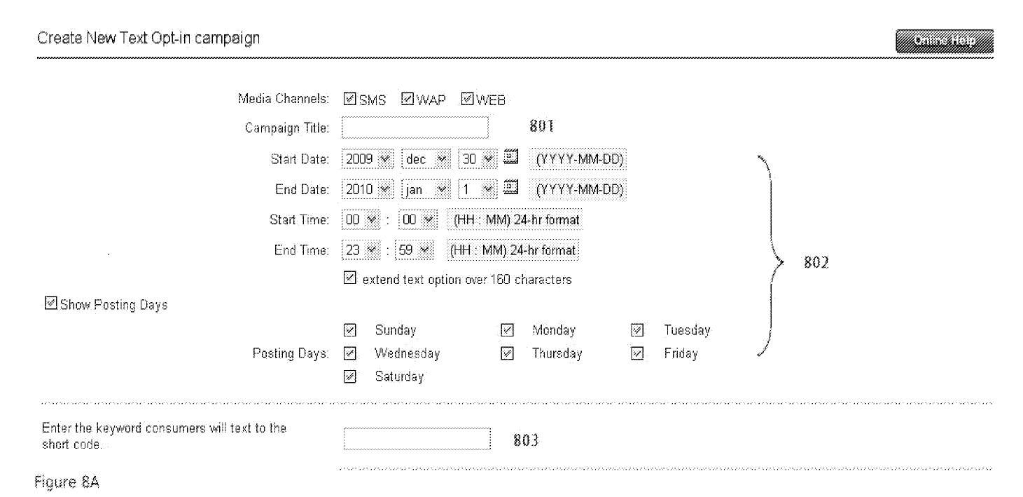

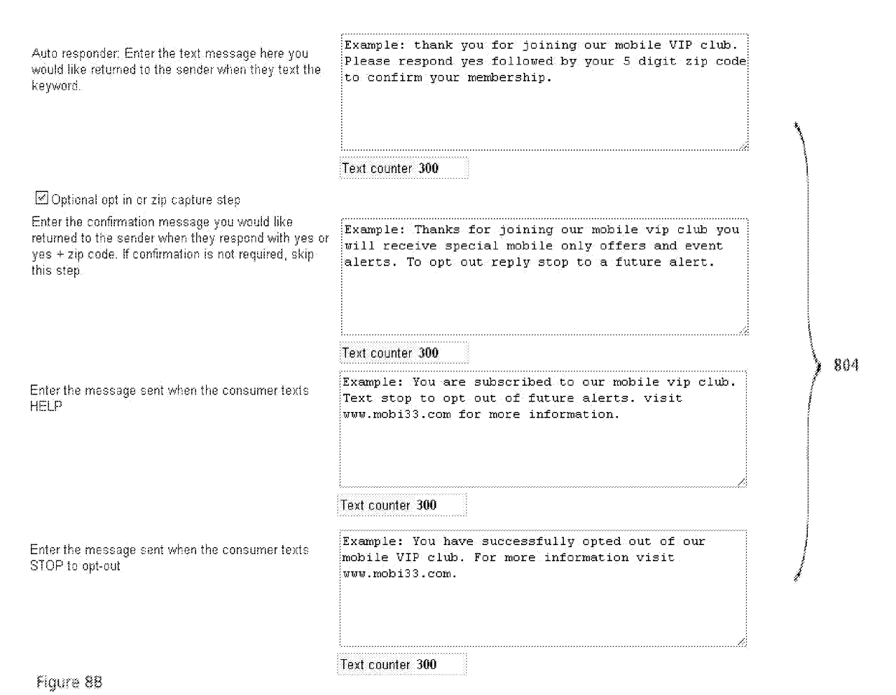

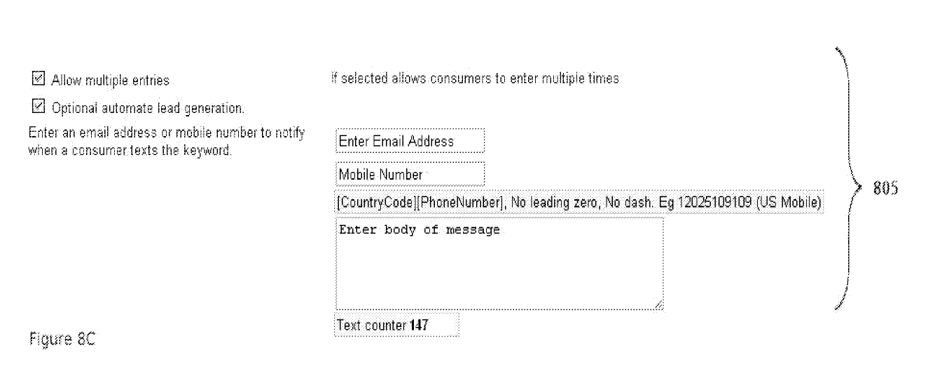

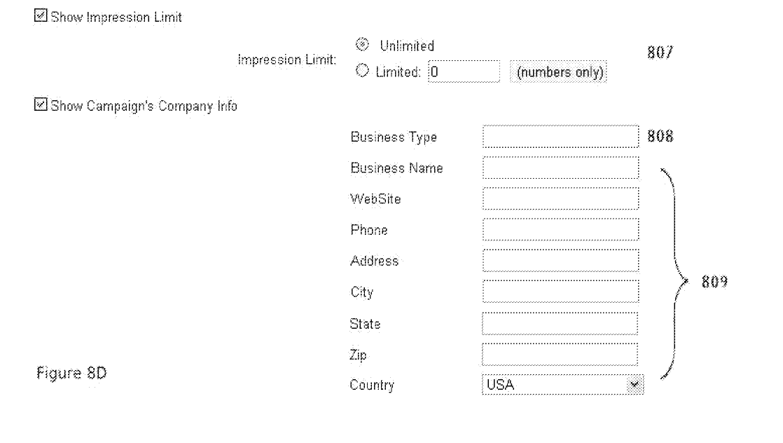

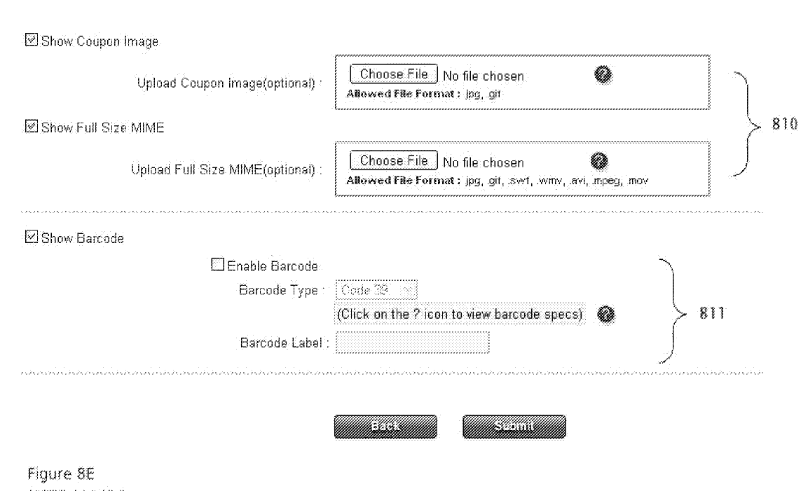

Referring to the embodiment shown in FIGS. 8A-8E, content providers can create content 800 using “Software as a Service” type of web based user interface provided by the system 160. The content providers can log in to the account and enter content information for each of the campaigns. Content can comprise campaign title 801, campaign schedule 802, campaign keywords 803, content or content location if stored in remote third party servers 804, content selection criteria 805/807/809, campaign attributes 808, content provider contact information 809, multi-media content 810 and barcode 811. Content data can be stored in system database or third party remote servers. Content providers can modify content information at any time.

Example Systems and Methods

Example systems can comprise of one or more of the following modules: a ‘Mobile Response Module’, a ‘Content Storage Module’, a ‘Content Exchange Module’, a ‘Content Tracking Module’, a ‘Content Redemption Module’, a ‘Content Delivery Module’, a ‘Content Creation Module’, an ‘Email Exchange Server’, a ‘Mobile App Server’, a ‘Web App Server’ and a ‘Private Branch Exchange Server’. These modules can be installed on the same or different servers. After a mobile response initiated by a “Mobile Call-to-action” is submitted by consumers and is received by the ‘Mobile Response Module’, data related to this event can be stored in the ‘Content Storage Module’ for future processing. Using the mobile response as an index, the ‘Mobile Response Module’ can locate the content that is associated with the ‘Mobile Call-To-Action’ and deliver the associated content back to consumers' mobile device. The ‘Mobile Response Module’ can then parse the associated content to the ‘Content Exchange Module’ for the selection of contextual content to be added the result before delivery. The ‘Content Exchange Module’ can tag the contextual content with information that can be used to track future content viewing activities by consumers and can also be used for click fraud prevention. Alternatively, the ‘Content Exchange Module’ can generate titles or short descriptions of the contextual content and convert them into tagged links instead of delivering the full content. After the contextual content or tagged links are generated, the ‘Content Delivery Module’ can select the mobile services for the delivery based on system criteria and consumers' preference. If redemption is required after content delivery, consumers can send a request to the ‘Content Redemption Module’ to redeem the content.

Example communications systems include an email exchange server, a private branch exchange server (PBX), a mobile app server, a web app server and an SMS server. These servers can be used to receive mobile responses and deliver content using various mobile services. Example methods include: (i) polling for incoming emails in the email exchange server; (ii) receiving voice calls in the PBX server with speech recognition software and text-to-speech software; (iii) sending and receiving data from mobile app in the mobile app server; (iv) sending and receiving data from the web app in the web app server; and (v) sending and receiving data from mobile aggregator in the SMS server.

Example systems for the implementation of the “Mobile Response Server” include a parser that interfaces to communication servers for the receiving of mobile responses, an algorithm to determine the mobile response type, and an algorithm to generate action list and a parser to parse the result to other modules. The mobile responses can be submitted by consumers using one or more mobile services. Example methods include: (i) consumers sending a text message to a short code with information given by a ‘Mobile Call-To-Action’; (ii) consumers calling from their mobile phone on a voice line and enter inputs using the dial pad with information given by a ‘Mobile Call-To-Action’; (iii) consumers sending an email or a text message to an email address with information given by a ‘Mobile Call-To-Action’; (iv) consumers using a mobile app to submit mobile responses with the information given by a ‘Mobile Call-To-Action’; (v) consumers connecting to a web app over the mobile Internet to submit mobile responses with the information given by a ‘Mobile Call-To-Action’; (vi) determining the mobile response type; (vii) generating the actions required for processing the mobile response; and (viii) sending data to other modules on the system.

Example systems for implementing the “Content Storage Server” include a relational database that contains mobile responses, consumer profiles and content viewing activities, servers that contains content associated to mobile responses, a relational database that contains content attributes such as keywords, target markets, locations associated to the content and others, application programming interfaces (APIs) to communicate with the system's databases or remote third parties' databases, content retrieval algorithms and content storage algorithms. Example methods include: (i) receiving requests for the retrieval of content from other modules; (ii) accessing content from databases locally or remotely using APIs; (iii) storing content and data submitted by other modules or remote third party servers; and (iv) retrieving content and parsing content to other modules.

Example systems for implementing the ‘Content Exchange Module’ include servers that contain the content selection algorithms associated with mobile responses, the contextual content selection algorithms for the content exchange and the content composition algorithms. Example methods include: (i) retrieving content that consumers are interested in receiving from the ‘Content Storage Module’; (ii) identifying the attributes of the content such as keywords, product categories and store location; (iii) identifying contextual content using content attributes and other system criteria; (iv) selecting contextual content to be delivered; (v) tagging content with encrypted links for tracking content viewing activities by consumers; (vi) composing final content to be delivered; and (vii) sending final content to the ‘Content Delivering Module’.

Example systems for implementing the ‘Content Tracking Module’ include the algorithms for tracking and recording content viewing activities, the algorithms for market analysis based on viewing activities and the algorithms for click fraud prevention. Example methods include: (i) receiving content viewing information including consumer profiles from mobile responses; (ii) recording viewing activities to the ‘Content Storage Module’; (iii) retrieving consumers' viewing history from the ‘Content Storage Module’; (iv) analyzing viewing statistics to ensure activities are legitimate; and (v) analyzing viewing statistics to optimize marketing effectiveness when serving contextual content.

Example systems for implementing the ‘Content Redemption Module’ include content redemption and validation algorithms. Example methods include: (i) receiving redemption input sent in from various mobile services; (ii) mapping the redemption to the original content sent to consumers; (iii) retrieving the redemption history of consumers; (iv) reviewing the redemption rules associated with the redemption; (v) sending redemption result back to consumers or store owners; (vi) updating result to merchants' point of sales systems using API (Application Programming Interface); (vii) conducting marketing surveys; and (viii) collecting marketing data back from consumers.

Example systems for delivering traceable mobile ad content with closed loop redemption capability to consumers' mobile phone initiated by a “Call-To-Action” statement placed in non-interactive or interactive ads or announced in hosted events or promotions include a ‘Content Request Module’, an ‘Ad Exchange Module’, a ‘Content Tracking Module’, a ‘Redemption Modules’, a ‘Content Delivery Module’ and a ‘Content Creation Module’. These modules may be installed on the same or different servers.

Consumers are usually interested in ads that offer similar content. These attributes may include product categories, store locations, and others. The selection of additional ads follows criteria that are set up in the system. The system may deliver just the titles of the additional ads or a link to a mobile web page instead of full content. A tracking method is used to provide the ability to trace back to individual consumers whenever the full content of the additional ads are being viewed. The system records information of the view activities which may comprise of the content ID, the attributes of the content, consumers' mobile number, date and time. The recorded information may be used for market analysis or behavioral targeting.

The assembled content is then delivered by the ‘Content Delivery Module’ using one or more of the available mobile channels. The mobile delivery channels may comprise voice, text messaging, email and mobile Internet. If the mobile content received by consumers requires user feedback or redemption, consumers may reply with special words such as more, email or redeem along with other information. After the ‘Closed Loop Redemption Module’ receives the consumers' reply, the module interprets the content and take appropriate action accordingly such as validate a coupon or ticket or send additional information back to consumers or store owners based on the result.

Example systems for implementing the ‘Content Request Module’ include a text message send and receive parser that interfaces to mobile aggregators, PBX (private branch exchange) servers that interface to VOIP (voice over IP) providers, an email parser that interfaces to an email exchange server and a mobile Internet web page that captures data from consumers. The content request sent in by consumers may come from various mobile channels. Example methods include: (i) consumers sending a text message to a short code with information given by the ‘Call-To-Action’ statement; (ii) consumers calling from their mobile phone to a voice line and enter inputs using the dial pad with information given by the ‘Call-To-Action’ statement; (iii) consumers sending an email or a text message to an email address with information given by the ‘Call-To-Action’ statement; and (iv) consumers going to a mobile web site to submit content request with the information given by the ‘Call-To-Action’ statement.

Example systems for implementing the ‘Ad Exchange Module’ include servers that contain the ad selection algorithms for the exchange, mobile delivery channel selection algorithms, and content composition algorithms. Example methods for assembling mobile content include locating ad content that consumers are requesting from the database, identifying the attributes of the requested content such as associated product categories and store location, identifying additional content with similar attributes, creating a list of the additional content that consumers may also be interested in, and composing the requested content and the titles of the additional content or a link to a mobile web page that contains the additional content.

Example systems for implementing the ‘Content Tracking Module’ include servers that contain the algorithms for tagging the ad content before delivering to consumers and for tracking the ad content whenever the content is being viewed. Example methods for tracking content include embedding consumers' mobile number in the mobile web page that contains the additional ad content, recording consumers' mobile number in the content request history whenever the mobile web page is being viewed, and extracting and recording consumers' mobile number from reply text messages when consumers request to view more ad content.

Example systems for implementing the ‘Closed Loop Redemption Module’ include servers that contain the closed loop redemption algorithms. Example methods for processing redemption may comprise a redemption request parser that: (i) receives redemption request sent by consumers or store owners—redemption request can be sent in using text messaging, dial pad entry over voice line, email or data capture from a mobile or online web page; (ii) maps the redemption request to the original ad content sent to consumers—the information that is being used to map to the original ad content sent to consumers may comprise consumers mobile phone number, data/time, redemption code and content ID; (iii) looks up the redemption history of consumers and the redemption rules associated with the requested redemption—the original ad content may comprise of coupons, promotions, sweepstakes, membership programs and event tickets; (iv) makes a decision based on the collected information and sends the status or result back to consumers and/or store owners—the status or result can be sent using one or more channels such as text messaging, voice, email and mobile/online web; and (v) interfaces to merchants' point of sales systems using API (Application Protocol Interface). The reply or redemption request sent in by consumers or store owners may contain additional information such as location ID of the store, the promotion package to be redeemed, consumers' feedback, personal data and others. The additional information may be used for market analysis or future promotions.

Example systems for implementing the ‘Content Delivery Module’ include a content delivery input parser, a mobile service selection algorithm, and a content delivery output parser that interfaces to the system's communication servers. Example methods include: (i) receiving content to be delivered from other modules; (ii) selecting mobile services for the content delivery based on system criteria and consumers' preference; (iii) delivering content to consumers using one or more mobile services; (iv) delivering redemption result to consumers or store owners using one or more selected mobile services; and (v) delivering content to third party remote systems using APIs.

Example systems for implementing the ‘Content Delivery Module’ include a text message send and receive parser that interfaces to mobile aggregators, PBX (private branch exchange) servers that interface to VOIP (voice over IP) providers, an email parser that interfaces to an email exchange server and a mobile or online Internet web page that displays the redemption status or result. Example methods include delivering requested ad content and additional ad titles or links to consumers using one or more of the communication channels described above, and delivering the redemption status or result to consumers and/or store owners using one or more of the communication channels described above. Content can also be delivered as speech over VOIP line using recorded voice or text-to-speech conversion mechanism.

Example systems for implementing the ‘Content Creation Module’ includes a ‘Software as a Service’ platform for content providers and advertisers to create content, content attributes, keywords, target markets, localization and others and stored the information in the systems' databases. Example methods include: (i) user sign up page; (ii) user log in page; (iii) content creation and edit pages; (iv) content statistics pages; (v) content broadcast pages; and (vi) campaign creation and edit pages. All content creation services are delivered over the Internet and stored in a database.

Exemplary Use Cases

The term “system” used in the exemplary use cases presented below refers to the system 160 of the present system and method, where the use cases can involve one or more modules for the applications.

In one embodiment, print media can tag its printed content including articles and ads with QR codes or SMS keywords. Using the present system and method, print media can port its content and ad inventories over to mobile, so that content providers can develop branded mobile portals where consumers can go directly for content. Print media can transition from being a traditional media to a “tradigital” media, i.e., using both traditional and digital media to publish content. For example, a newspaper ad offers a coupon to consumers, consumers can text a keyword to a short code and receive the coupon as SMS. Alternatively, consumers can use a mobile app and the mobile phone's built-in camera to scan in a QR code to submit a mobile response for the coupon. The decoded message can then be sent to the system via the mobile app or other mobile services. The present system can identify consumers' area of interest from the mobile response and deliver additional contextual content along with the coupon. The mobile response submitted by the consumers can also be saved on the system and consumers can review the content associated with the saved mobile responses using a mobile app or a web app at any time. The system can serve additional contextual content based on the attributes of the content associated with the saved mobile responses during content review.

In another embodiment, a QR code or a “Mobile Call-To-Action” can be printed on merchandise price tags or printed on the merchandise itself Consumers can save the information associated with the merchandise by submitting their mobile response to the system. For example, consumers can scan in the QR code using a mobile app or text a keyword to a short code. The system can then save the mobile response on the system's database. The mobile response can serve as an index to content or information that is associated with the merchandise. Information can comprise product description, merchandise image, the location of the store, product availability and pricing. Consumers can log on to their account to review content that is associated with the mobile responses that they have saved. During content review, the system can identify the type of content that consumers are interested in. The system can then suggest additional merchandises that consumers may also be interested in. The additional suggestions can be displayed as tagged links to pages on the mobile app or on the web app, when consumers click on the links, the system can record the viewing activities and charge back to the content providers.

In yet another embodiment, consumers can share the content that they have saved with others. Consumers have the options of: (i) keeping the content private; (ii) sharing the content with people that consumers approved; and (iii) sharing the content with the public. Followers of the consumers whose content is being shared can be alerted by SMS, email or other mobile services when new content is being saved by consumers. Followers can log on to read the new content using mobile app, web app or other mobile services. Content can also be viewed online During content access by followers, the system can detect followers current interest based on the content attributes. The system can send along additional tagged links of the contextual content that followers may also be interested in viewing. When followers click on the links, the system will record the viewing activities.

In yet another embodiment, consumers can submit content that they themselves want to create such as taking a picture of an item while shopping and entering information about the item. If consumers is using a mobile app or a web app provided by the system to submit content, the location of the consumers can be detected using GPS or other location detection technologies and can be submitted as part of the content. The system can convert the location information into store or business address if it is found in the database or from public domain. Consumers can submit content that they have created using SMS, email, mobile app or web app. Consumers can review the saved content by logging on to the system. Consumers can also share content that they have created with followers. The system can also use information entered by consumers and identify keywords that help to locate contextual content to be served during content review. If consumers submit a picture of an article with text and if there is enough resolution in the picture, the system can use recognition software to extract the article text and save the text along with the picture. Using the extracted text, the system can identify contextual content that can be served to consumers during content review.

It is understood that the present invention is not limited to these specific embodiments and details, which are exemplary only. Furthermore, the use of the invention for its intended purposes and benefits could be in any number of alternative embodiments, depending upon specific design and other needs. It is understood that terms in singular form may be used interchangeably in their plural form. It is also understood that the term ‘content’ and the term ‘ad content’ may be used interchangeably as content may or may not be of advertising in nature. Also, the term ‘mobile services’ refer to technologies that are being used to allow consumers to communicate with the systems described and claimed herein, using a mobile device, such as submitting mobile responses to the system or receiving content from the system. New mobile services may emerge over time and they will be considered as part of the system and method claimed herein.

What I claim is:

1. A method for serving content to a mobile device in response to a content request over a mobile communication channel, comprising the steps of:
A. by a mobile response server:
i. receiving over the mobile communication channel, a content request, and ID data representative of the identity of the mobile device;
B. by a content storage server:
i. storing the received request data in association with the ID data;
C. by a content exchange server, in response to the stored content request:
i. identifying attributes of the stored request data, wherein the attributes are related to the content request;
ii. identifying contextual data having content related to the identified attributes; and associating the contextual data with the stored request data; and
D. by a content delivery server:
i. composing a response-to-mobile device message, wherein the message includes message data related to the contextual data;
ii. storing the composed response-to-mobile device message; and
iii. transmitting composed response-to-mobile device message.

2. The method of claim 1, wherein the contextual data includes additional data having content related to attributes related to but distinct from the identified attributes.

3. The method of claim 2, further comprising the further steps of:
E. by a content tracking server:
i. for at least a portion of the contextual data, generating traceable content associated with the additional content of the contextual data, wherein the traceable content is representative of an audit trail relating to the additional content of the contextual data; and
ii. storing pointer data in associated with the stored content request, wherein the pointer data is representative of the location of the additional data of the contextual data.

4. The method of claim 3 wherein the pointer data is a link.

5. The method of claim 3, wherein the content delivery server composes the response-to-mobile device message whereby the message data includes information related to the additional data of the contextual data.

6. The method of claim 1, wherein the mobile response server is responsive to a subsequent content request received from the mobile device, to enable the content delivery server to compose a response-to-mobile device subsequent message, wherein the subsequent message includes subsequent message data representative of the then-current stored contextual data.

7. The method of claim 1, wherein the mobile response server is responsive to a subsequent content request received from the mobile device, wherein the content request includes a portion indicative of a request to review stored request data associated with the mobile device, to enable the mobile device to gain viewing access to the contextual data associated with the stored request data associated with the mobile device.

8. The method of claim 1 wherein the content request is related to a mobile call-to-action statement.

9. The method of claim 8 wherein the mobile call-to-action statement is non-interactive.

10. The method of claim 8 wherein the non-interactive statement is on a physical medium.

11. The method of claim 8 wherein the contextual data is representative of one or more coupons for redemption in connection with goods offered for sale pursuant to the mobile call-to-action statement.

12. The method of claim 8 wherein the contextual data is representative of transaction parameters in connection with goods offered for sale pursuant to the mobile call-to-action statement.

13. The method of claim 1 wherein the mobile communication channel includes the Internet, supporting one from the group consisting of:
i. voice by way of a VOIP provider and a private branch exchange (PBX);
ii. text message by way of an SMS server and a mobile aggregator;
iii. mobile web by way of a web app server;
iv. e-mail by way of an Internet gateway and an e-mail exchange server; and
v. text-to-e-mail by way of an SMPT gateway and an e-mail exchange server.

14. The method of claim 1 further comprising:
by a content creation server,
i. in response to contextual change data received from one or more context provider parties, updating the contextual data associated with the stored request data, whereby the updated contextual data is representative of an updated version of the contextual data.

15. The method of claim 1 wherein the transmitting is by way of a mobile communication channel.

16. The method of claim 1 wherein the transmitting is by way of email over the internet.

17. The method of claim 1 wherein the request data is associated with a mobile call-to-action statement.

18. The method of claim 17 wherein the mobile call-to-action statement is non-interactive.

19. The method of claim 18 wherein the non-interactive statement is on a physical medium.

20. The method of claim 1 wherein the request data is related to a redemption related to a transaction associated with goods or services.

21. The method of claim 1 comprising the further steps of:
by a content redemption server:
i. identifying redemption portion of the received content request indicative of a desired redemption trans action associated with the contextual data, wherein the redemption transaction is defined by terms associated with the transaction; and
ii. in response to the redemption identification, effecting a redemption associated with the transaction in accordance with the terms.

22. The method of claim 21 comprising the further step of, by the content redemption server, effecting the redemption transaction.

23. The method of claim 1 wherein the request data is associated with a review of the stored received content.

24. The method of claim 23 comprising the further steps of:
by the mobile response server:
i. identifying the received content request indicative of a desired review associated with the contextual data, wherein the stored contextual data for which review is requested is defined by content request; and
iii. in response to the review identification, enabling viewing access by the mobile device, to the requested contextual data of the stored request data associated with the mobile device.

25. The method of claim 1 comprising the further step of, by the content exchange server: in connection with the contextual data, embedding a tag in the contextual data, wherein the tag is representative of the ID data of the content request.

26. The method of claim 25 comprising the further step of, by the content exchange server, generating a content ID associated with the contextual data.

27. The method of claim 26 comprising the further steps of:
by the content exchange server:
i. combining the contextual data and the content ID associated with the contextual data,
encrypting the combined contextual data and content ID; and
ii. associating a set of rules with the contextual data and the content ID associated with the contextual data,
wherein the rules define permitted usage of and/or access to the combined contextual data and the content ID associated with the contextual data.

28. The method of claim 27 wherein the rules define at least one from the group consisting of: number of times the mobile device is allowed access; range of times the mobile device is allowed access; number of mobile devices to which the mobile device may authorize access; and, the identity of mobile devices to which the mobile device may authorize access.

29. The method of claim 28 comprising the further step of, by the content exchange server, controlling access to and/or usage of the combined contextual data and the content ID associated with the contextual data in accordance with the rules.

30. The method of claim 1 comprising the further steps of:
by the content creation server:
i. making available to a content provider (CP), a software as a service web-based user interface;
ii. in response to a log-on by a content provider, and receipt of a signal from the content provider, indicative of a content provider-desired campaign, generating provider-directed content representative of the content provider-desired campaign and CP ID data representative of the identity of the content provider; and
iii. storing the provider-directed content in association with the CP ID data.

31. The method of claim 30 comprising the further steps of:
by a content creation server:
i. associating a set of rules with the provider-directed content and the CP ID data associated with provider-directed content,
wherein the rules define permitted usage of and/or access to the provider-directed content and the CP ID data associated with the provider-directed content.

32. The method of claim 31 wherein the rules define, with respect to the provider-directed content, at least one from the group consisting of: number of times the mobile device is allowed access; range of times the mobile device is allowed access; number of mobile devices to which the mobile device may authorize access; and, the identity of mobile devices to which the mobile device may authorize access.

33. A system for serving content to a mobile device in response to a content request over a mobile communication channel, comprising:
A. a mobile response server, for receiving over the mobile communication channel, a content request, and ID data representative of the identity of the mobile device;
B. a content storage server, in communication with the mobile response server, for storing the received request data in association with the ID data;
C. a content exchange server, in communication with the content storage server and responsive to the stored content request, wherein the content exchange server:
i. identifies attributes of the stored request data, wherein the attributes are related to the content request;
ii. identifies contextual data having content related to the identified attributes; and
iii. associates the contextual data with the stored request data; and
D. a content delivery server, in communication with the content storage server and content exchange server, for:
i. composing a response-to-mobile device message, wherein the message includes message data related to the contextual data;
ii. storing the composed response-to-mobile device message; and
iii. transmitting composed response-to-mobile device message.

34. The system of claim 33, further comprising:
E. a content tracking server, in communication with the mobile response server and content creation server, for at least a portion of the contextual data:
i. generating traceable content associated with the additional content of the contextual data, wherein the traceable content is representative of an audit trail relating to the additional content of the contextual data; and
ii. storing pointer data in associated with the stored content request, wherein the pointer data is representative of the location of the additional data of the contextual data.

35. The system of claim 33 further comprising:
F. a content creation server, in communication with the content deliver server, content storage server, content exchange server, content tracking server, and content redemption server, for, in response to contextual change data received from one or more context provider parties, updating the contextual data associated with the stored request data, whereby the updated contextual data is representative of an updated version of the contextual data.

36. The system of claim 33 further comprising:
G. a content redemption server, in communication with the mobile response server for:
i. identifying redemption portion of the received content request indicative of a desired redemption trans action associated with the contextual data, wherein the redemption transaction is defined by terms associated with the transaction; and
ii. in response to the redemption identification, effecting a redemption associated with the transaction in accordance with the terms.
